(19) United States
(12) Patent Application Publication
(10) Pub. No.: US 2005/0261019 A1
(43) Pub. Date: Nov. 24, 2005

(54) Mobile terminal for preventing static and method thereof

(75) Inventors: Sang-Hoon Lee, Anyang (KR); Byung-Duck Park, Anyang (KR)

Correspondence Address: BIRCH STEWART KOLASCH & BIRCH, PO BOX 747, FALLS CHURCH, VA, 22040-0747, US

(73) Assignee: LG. Electronics Inc.

(21) Appl. No.: 11/118,354

(22) Filed: May 2, 2005

(30) Foreign Application Priority Data
Apr. 30, 2004 (KR) 10-2004-0030754

(51) Int. Cl. H04M 1/00; H04B 1/38

(52) U.S. Cl. 455/550.1; 455/90.3

(57) ABSTRACT

A mobile terminal capable of preventing accumulation of static and a method thereof. The terminal includes a key on which a conductive layer is formed, a ground path for conducting and discharging electrostatic, and a conducting path for conducting the static channeled to the key on which the conductive layer is formed to the ground path. Accordingly, malfunctioning of the mobile terminal caused by static being introduced into the periphery of the keys of the key pad is prevented, and inner components are prevented from being damaged.

### BACKGROUND OF THE INVENTION

1. Field of the Invention

The present invention relates to a mobile terminal, and more particularly, to a mobile terminal capable of preventing accumulation of static electricity and to thereby prevent a the mobile terminal from malfunctioning and to prevent inner components of the mobile terminal from being damaged, and a method thereof.

2. Description of the Conventional Art

Generally, a mobile terminal is a communication device capable of performing a voice transmission/reception with another party elsewhere and is generally simply carried by a user. Information communication technology has progressed and the mobile terminal can also transmit/receive text messages to/from another party, access the internet, and receive TV signals. The mobile terminal can also function as a camera capable of taking still photographs and motion videos. The camera can also transmit and receive the still photographs and motion videos. Fields to which the mobile terminal is applied are continuously being developed.

The mobile terminal can generally be divided into different types according to an external form of the mobile terminal—a bar type mobile terminal, a flip type mobile terminal, a folder type mobile terminal, a slider type mobile terminal. The bar type mobile terminal is provided with a body having a PCB therein, keys, a display, a speaker, a microphone, etc. The flip type mobile terminal includes a body, and a flip rotatably coupled to one side of the body. The body of the flip type mobile terminal is provided with keys, a display, a microphone, etc., and the flip is provided with a speaker. The folder type mobile terminal includes a body, and a folder rotatably coupled to one side of the body. The body of the folder type mobile terminal is provided with keys, a microphone, etc., and the folder is provided with a display, a speaker, etc. The slider type mobile terminal includes a body, and a slider slidably coupled to one side of the body. The body of the slider type mobile terminal is provided with keys and a microphone, and the slider is provided with a display and a speaker.

The mobile terminal receives a call when a reception key is pressed to communicate with another party when the call originates from the other party. The mobile terminal originates the call when input keys and a send key are pressed to communicate with the other party. When the internet is accessed or text message are sent by using the mobile terminal, input keys are used.

However, when the user inputs a message, initiates or receives a call, etc. by using the keys, static electricity may be generated due to the user's contact with the keys or due to a contact between an object and the keys. This may introduce static into the mobile terminal through gaps between the keys. The static introduced into the mobile terminal may damage the software of the mobile terminal and thereby cause the mobile terminal to malfunction. The static may also damage the hardware. As the capabilities of the mobile terminal increases, the damage due to the static becomes correspondingly more significant.

A static preventing unit can be provided on surfaces of the keys to prevent the static from affecting the mobile terminal. However, it is difficult to completely prevent the static from being applied to the periphery of the keys by such static preventing unit. Accordingly, the damage due to the static has not been completely solved.

### SUMMARY OF THE INVENTION

Therefore, an object of the present invention is to provide a mobile terminal capable of preventing static electricity from being accumulated to thereby prevent the mobile terminal from malfunctioning due to static being applied to the periphery of a key pad and being introduced into the mobile terminal and a method thereof. The mobile terminal can also prevent the inner components from being damaged.

To achieve these and other advantages and in accordance with the purpose of the present invention, as embodied and broadly described herein, a mobile terminal of an embodiment of the present invention includes a key or keys on which a conductive layer is formed; a ground path for conducting and discharging static electricity; and a conducting path for conducting to the ground path the static electricity being applied on the key or keys on which the conductive layer is formed.

In another embodiment of the present invention, the mobile terminal includes a casing; a key pad provided with a key or keys on which a conductive layer is formed and mounted in the casing; and a main board mounted in the casing; a ground path provided at the casing or at the main board for conducting and discharging static electricity; and a conducting path for conducting to the ground path the static electricity applied to the key or keys on which the conductive layer is formed.

According to another embodiment of the present invention, a method for preventing static in a mobile terminal includes: channeling static electricity to a key or keys on which a conductive layer is formed; conducting the static electricity that has been channeled to the key through a conducting path formed in a terminal body; and conducting and discharging through a ground path the static electricity that has been conducted through the conducting path.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a disassembled perspective view showing a body of a mobile terminal capable of preventing accumulation of static according to an embodiment the present invention;

FIG. 2 is a sectional view showing the body of the mobile terminal according to the embodiment present invention;

FIG. 3 is a disassembled perspective view showing a body of a mobile terminal capable of preventing accumulation of static with an electron emitting pad according to an embodiment of the present invention;

FIG. 4 is a disassembled perspective view showing a body of a mobile terminal capable of preventing accumulation of static according to a second embodiment of the present invention;

FIG. 5 is a disassembled perspective view showing a body of a mobile terminal having capable of preventing accumulation of static according to a third embodiment of the present invention;

FIG. 6 is a disassembled perspective view showing a body of a mobile terminal capable of preventing accumulation of static according to a fourth embodiment of the present invention;

FIGS. 7 and 8 are sectional views showing modification examples of a key pad of the mobile terminal according to embodiments of the present invention; and

FIG. 9 is a flowchart showing a method for preventing accumulation of static in a mobile terminal according to an embodiment of the present invention.

### DETAILED DESCRIPTION OF THE PREFERRED EMBODIMENTS

Reference will now be made in detail to the preferred embodiments of the present invention, examples of which are illustrated in the accompanying drawings. Hereinafter, the mobile terminal capable of preventing accumulation of static according to embodiments the present invention will be explained in more detail.

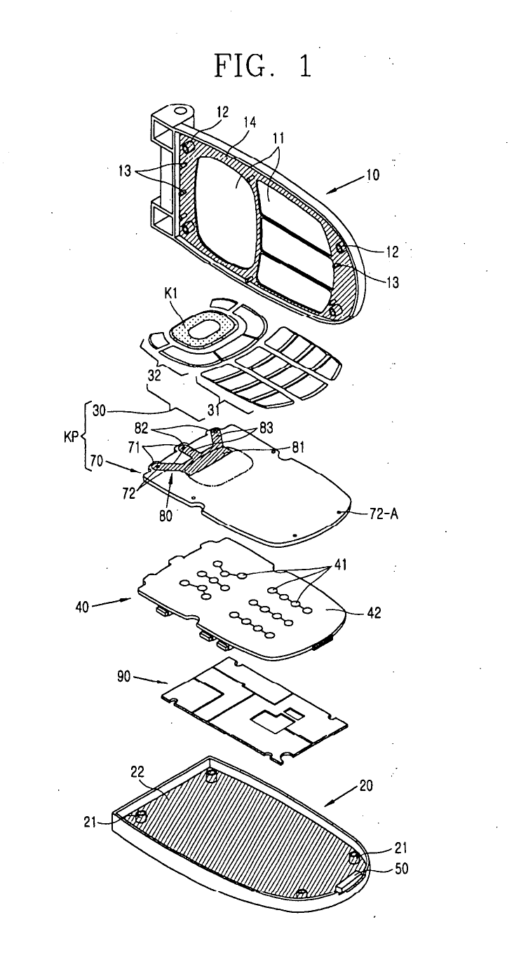

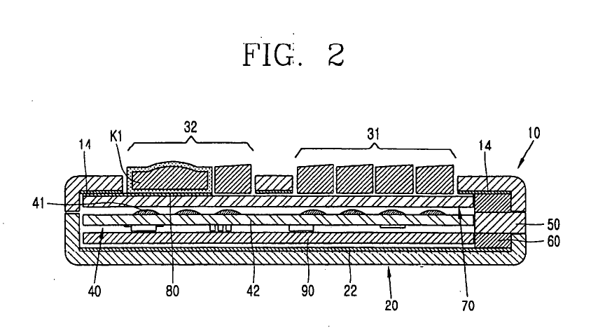

FIG. 1 is a disassembled perspective view showing a body of a mobile terminal capable of preventing accumulation of static according to an embodiment of the present invention, and FIG. 2 is a sectional view showing the body of the mobile terminal according to the embodiment of the present invention.

As shown, the mobile terminal may have a body including a casing composed of a front case 10 and a rear case 20, a key pad KP having a plurality of keys 30 mounted in the casing so that the keys 30 can be exposed to outside of the casing, and a main board 40 provided with a plurality of dome switches 41 corresponding to the keys 30 of the key pad KP mounted in the casing.

The front case 10 may be provided with a plurality of key holes 11 for inserting the keys 30 of the key pad KP at a front surface thereof and a plurality of boss portions 12 for coupling by screws (not shown) protruding from an inner surface of the front case 10. A plurality of stopping pins 13 may also protrude from the inner surface of the front case 10. The front case 10 may further be provided with a ground path 14 for conducting and discharging static electricity. The ground path 14 of the front case 10 may be a conductive thin film formed on an entirety of the inner surface of the front case 10. The conductive thin film is preferably formed by spraying an EMI material. The conductive thin film preferably has a resistance value less than 1.2 Ω.

The rear case 20 may be provided with a plurality of boss portions 21 corresponding to the boss portions 12 of the front case 10 at an inner surface thereof. The rear case 20 may also be provided with a ground path 22 for conducting and discharging static electricity. The ground path 22 of the rear case may be a conductive thin film formed on an entirety of the inner surface of the rear case 20. The conductive thin film is preferably formed by spraying an EMI material. The conductive thin film has preferably a resistance value less than 1.2 Ω.

Preferably, the ground path 14 of the front case 10 and the ground path 22 of the rear case 20 are electrically connected to each other, through direct physical contact or through other means, when the front case 10 and the rear case 20 are coupled to each other. The ground path 14 formed at the boss portions 12 of the front case 10 may be electrically connected to the ground path 22 formed at the boss portion 21 of the rear case 20 by physical contact for example.

An I/O connector 50 may be mounted at an end of one side of the rear case 20. The I/O connector 50 may be formed from a conductive metal. Preferably, the ground path 22 of the rear case 20 is electrically connected to the I/O connector 50. The ground path 22 of the rear case 20 may be electrically connected to the I/O connector 50 via a conductive gasket 60 (illustrated in FIG. 2).

The front case 10 and the rear case 20 may be formed from a plastic material.

The key pad KP may include a pad 70 formed from a flexible material to have a certain thickness and an area. The key pad KP may also include a plurality of keys 30 attached to the pad 70.

The pad 70 may be provided with a plurality of extension portions 71 on one side thereof and a through hole 72 formed at each of the extension portions 71. When the key pad KP and the front case 10 are coupled to each other, the stopping pins 13 of the front case 10 may be respectively inserted into the through holes 72 formed at each of the extension portions 71. A plurality of the through holes 72-A may also be formed at portions of the pad 70 where the extension portions 71 are not present and corresponding to the stopping pins 13 of the front case 10. The pad 70 may be formed from a rubber material.

The keys 30 of the key pad KP may include number keys 31 for inputting numbers and characters and operation keys 32 for inputting operation commands. The number keys 31 and the operation key 32 may be attached to one surface of the pad 70. The number keys 31 and the operation keys 32 generally occupy different regions.

A conductive layer may be formed on one or more of the keys 30 including the number keys 31 and the operation keys 32. Preferably, the conductive layer is formed on a key that has the largest area or on a key most frequently used. For example, one of the operation keys 32 may be frequently used. The conductive layer formed on the keys 30 may also enhance the appearance of the product.

The key pad KP may be provided with a conducting path 80 for conducting the static. The conducting path 80 may be formed from a thin film patterned on the surface of the pad 70 to which the keys 30 are attached. The conducting path 80 may include a first ground portion 81 formed in a region to which a key K1 is attached with a shape conducive for making contact with the key K1 on which a conductive layer is formed The conducting path 80 may also include second ground portions 82 respectively formed at each of the extension portions 71 of the pad and may further include a connection portion 83 for connecting the first ground portion 81 to the second ground portions 82.

The thin film is preferably formed from carbon, copper, gold, silver, etc. A resistance value of the conducting path 80 is preferably less than 10 Ω.

As an alternative, the conducting path 80 provided at the key pad KP may be formed from a conductive thin film tape (not shown) having the shape conducive for making contact. The conductive thin film tape may be attached to the pad 70.

The main board 40 may include a substrate 42, components may be mounted on one surface of the substrate 42, and a plurality of dome switches 41 may be provided on another surface of the substrate 42. The keys 30 of the key pad KP respectively correspond to the dome switches 41.

Numeral 90 denotes an inner cover.

Components of the terminal body may be assembled as follows.

The key pad KP may be coupled to the front case 10 so that the keys 30 of the key pad KP are positioned at the key holes 11 of the front case 10. The stopping pins 13 of the front case 10 may be respectively inserted into the through holes 72 and 72-A of the key pad KP. The second ground portion 82 of the conducting path 80 formed on the key pad KP may be connected to the ground path 14 of the front case 10. The key K1 on which the conductive layer is formed may be in contact with the first ground portion 81 of the conducting path 80.

The main board 40 may be positioned so that the surface of the main board 40 with the dome switches 41 can be in contact with a surface of the key pad KP opposite to the surface where the keys 30 not positioned. Also, the inner cover 90 may be in contact with the main board 40.

The front case 10 and the rear case 20 may be coupled to each other by respectively coupling the boss portions 12 of the front case 10 to the boss portions 21 of the rear case 20, for example by screws (not shown).

An operation of the the mobile terminal according to the present invention will be explained as follows.

When static is generated on to the periphery of the keys 30 due to the mobile phone being in contact with an object or due to a user pressing the keys 30, the static can be channeled to the key K1 on which the conductive layer is formed. The static flows to the ground paths 14 and 22 through the conducting path 80, and then is discharged outward through the casing, the screws coupled to the casing, and/or the I/O connector 50 mounted at the casing.

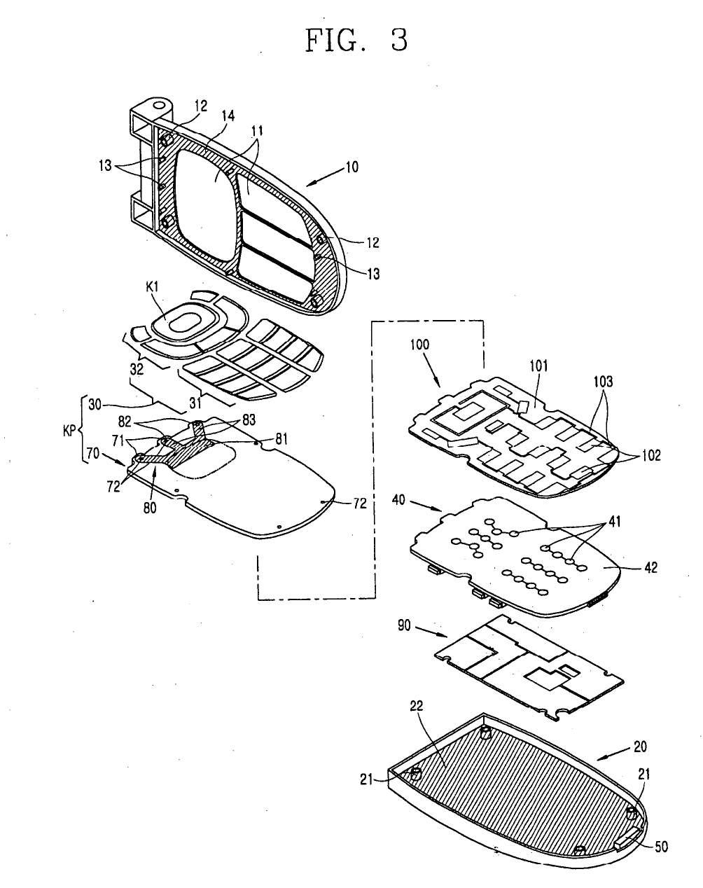

FIG. 3 is a disassembled perspective view showing a body of a mobile terminal provided with an electron emitting key pad. The same reference numerals denote the same parts as those of the aforementioned embodiments.

The front case 10, the rear case 20, the main board 40, and the inner cover 90 may have a construction similar to those of the aforementioned embodiments.

The key pad KP may also have a similar construction as the aforementioned embodiments, and the pad thereof may be formed from a transparent material.

An electron emitting key pad 100 may include a pad 101 and electron emitting lamps 102 arranged on the pad 101. The electron emitting lamps 120 may be connected to one another via a connection line 103 patterned on the pad 110 and lit by a driving circuit portion (not shown).

The electron emitting key pad 100 may be positioned between the main board 40 and the key pad KP, and can be inserted into the pad 70 of the key pad KP.

The mobile terminal having the electron emitting key pad 100 implements an alternative appearance due to the light being emitted from the electron emitting lamps 102 of the electron emitting key pad 100.

A second embodiment of the mobile terminal according to the present invention will be explained as follows.

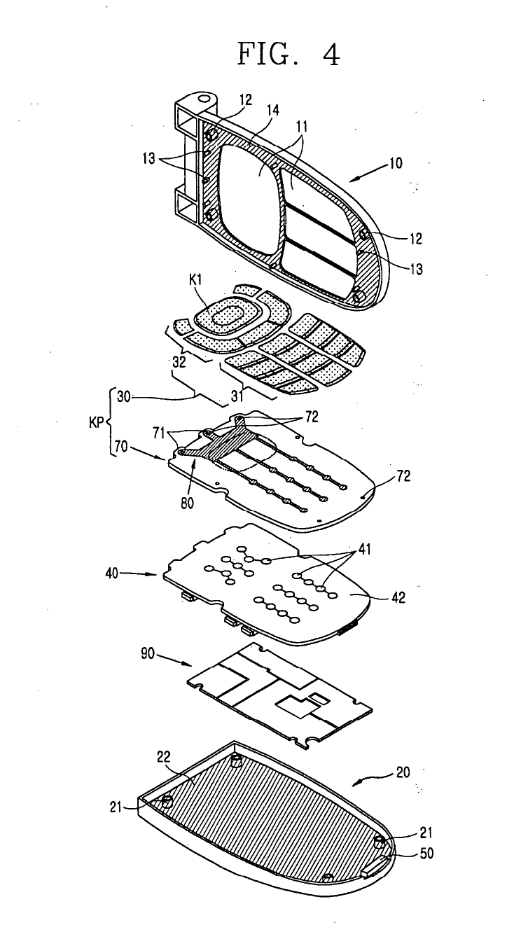

FIG. 4 is a disassembled perspective view showing a body of a mobile terminal having an static preventing apparatus according to the second embodiment of the present invention. The same reference numerals denote the same parts as those of the aforementioned embodiments.

The front case 10, the rear case 20, and the main board 40 may be constructed in a manner similar to those of the aforementioned first embodiment. A conductive layer may be formed on one or more keys 30 including the number keys 31 and the operation keys 32 of the key pad KP.

A pad 70 of the key pad KP may be provided with a conducting path 80 on one surface thereof. The conducting path 80 may connect with the keys 30 on which the conductive layer is formed. The keys 30 may be attached to the surface of the pad 70 where the conducting path 80 is formed. The conducting path 80 may be formed from a thin plate patterned in a shape for connecting with the keys 30 with the conductive layer. Preferably, the thin plate is formed of a conductive material such as carbon, copper, gold, silver, etc.

When the key pad KP is mounted on the front case 10, the conducting path 80 formed at the key pad KP may be in contact with the ground path 14.

An operation of the the mobile terminal according to the second embodiment will be explained as follows.

When static is channeled on the periphery of the keys 30, the static can be introduced into the keys 30 on which the conductive layer is formed. Then, the static flows on to the ground paths 14 and 22 through the conducting path 80, and then is discharged outward through the casing, the screws coupled to the casing, and/or the I/O connector 50 mounted at the casing.

An operation of a mobile terminal according to a third embodiment of the present invention will be explained as follows.

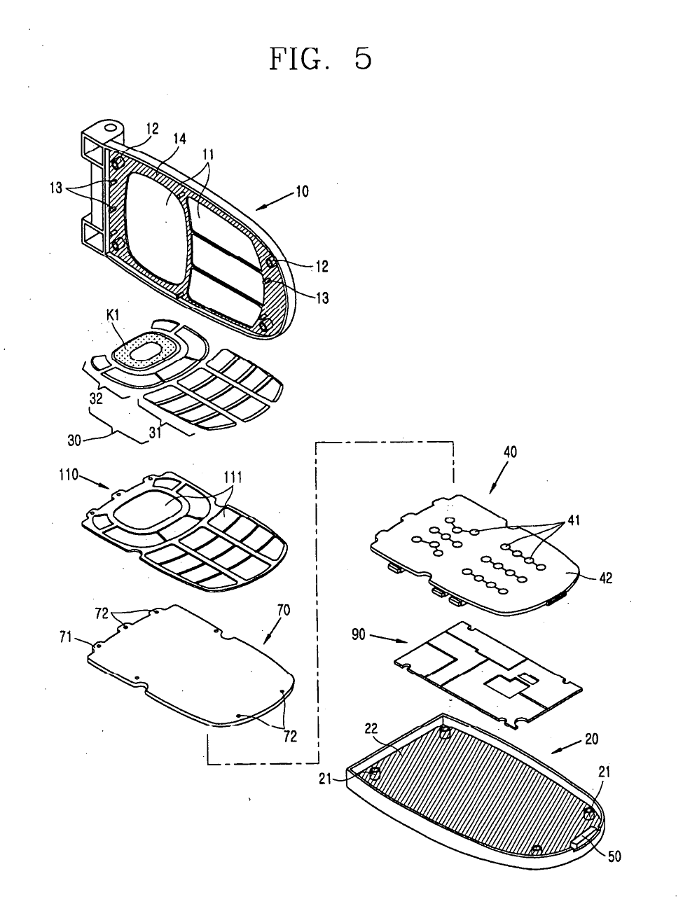

FIG. 5 is a disassembled perspective view showing a body of the mobile terminal capable of preventing accumulation of static according to the third embodiment of the present invention. The same reference numerals denote the same parts as those of the aforementioned embodiments.

The front case 10, the rear case 20, the main board 40, and the inner cover 90 may be constructed in a similar manner as those of the aforementioned embodiments. The key pad KP may be composed of a pad 70 formed from a flexible material to have a certain thickness and an area, and a plurality of keys 30 may be attached to the pad 70. A conductive layer may be formed on one or more keys of the keys 30. However, as shown, the pad 70 need not be provided with a conducting path.

Instead, a conducting plate 110 formed from a conductive material coupled between the front case 10 and the key pad KP may be included.

The conducting plate 110 may be a thin plate matching the form of the pad 70, and may be provided with key holes 111 corresponding to the keys 30 of the key pad KP therein. The conducting plate 110 may be positioned on a surface of the pad 70 where the keys 30 are formed and coupled to the front case 10 along with the key pad KP. The conducting plate 110 may be electrically connected, for example through direct physical contact, to the ground path 14 of the front case 10.

An operation of the mobile terminal according to the third embodiment will be explained as follows.

When static is channeled on the periphery of the keys 30, the static flows on to the ground paths 14 and 22 through the conducting plate 110. Then, the static is discharged outward through the casing, the screws coupled to the casing, and/or the I/O connector 50 mounted at the casing.

An operation of the mobile terminal according to a fourth embodiment of the present invention will be explained as follows.

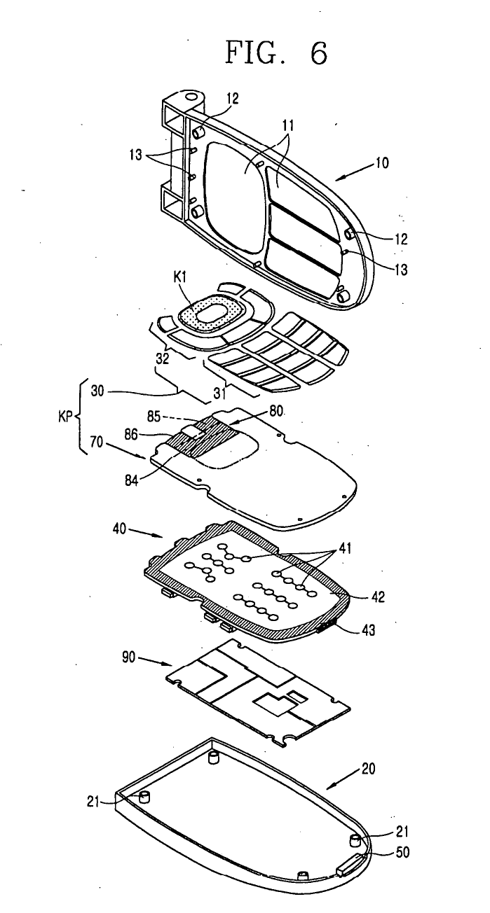

FIG. 6 is a disassembled perspective view showing a body of the mobile terminal capable of preventing accumulation of static according to the fourth embodiment of the present invention. The same reference numerals denote the same parts as those of the aforementioned embodiments.

The front case 10 and the rear case 20 may be constructed in a similar manner as those of the aforementioned embodiments except that the ground path need not be provided on the front and rear cases 10 and 20.

The key pad KP mounted on the front case 10 may be composed of a pad 70 formed from a flexible material to have a certain thickness and an area, and a plurality of keys 30 attached to the pad 70. The key pad KP may be provided with a conducting path 80.

A conductive layer may be formed on one or more keys of the keys 30 including number keys 31 and operation keys 32. if the conductive layer is formed on one key, it is preferable that the key with the largest area or the key most frequently used be chosen to have the conductive layer formed. As an example, the case wherein the conductive layer is formed on the key K1 as shown will be explained.

The conducting path 80 may include a third ground portion 84 formed at a region corresponding to where the key K1 is attached with a shape conducive for making contact with the key K1. The conducting path may also include a fourth ground portions 85 formed on an opposite surface of the pad 70 to which the third ground portion 84 is attached and a connection portion 86 for connecting the third ground portion 84 to the fourth ground portions 85. The connection portion 86 may penetrate through the pad 70 or can be formed on a side surface of the pad 70.

The conducting path 80 including the third ground portion 84, the fourth ground portion 85, and the connection portion 86 can be shaped from a thin plate. The thin plate is preferably formed from carbon, copper, gold, silver, etc. A resistance value of the conducting path 80 is preferably less than 10 Ω.

As an alternative, the conducting path 80 provided may be formed from a conductive thin film tape (not shown). The conductive thin film tape may be attached to the pad 70.

The conducting path 80 may be connected to key or keys on which the conductive layer is formed.

The main board 40 may include a substrate 42 having a certain shape, components may be mounted on one side of the substrate 42 and a plurality of dome switches 41 may be provided on the other surface of the substrate 42. The dome switches 41 may be formed at positions corresponding to the keys 30 of the key pad KP. The substrate 42 may be provided with a ground path 43. The ground path 43 may be formed from a conductive thin film and shaped to have a certain area at an edge of the substrate 42. The conductive thin film is preferably formed by spraying an EMI material. The conductive thin film has preferably a resistance value less than 1.2 Ω.

Preferably, the ground path 43 formed at the main board 40 is electrically connected to the I/O connector 50 mounted at the end of one side of the rear case 20.

Components of the mobile terminal according to the fourth embodiment may be assembled to one another as follows.

The front case 10, the rear case 20, the inner cover 90, the main board 40, and the key pad KP may be assembled to one another in a manner similar to the aforementioned embodiments.

The keys 30 may be attached to the pad 70, and the key K1 on which the conductive layer is formed may be in contact with the third ground portion 84 of the conducting path 80.

The fourth ground portion 85 of the conducting path 80 may be in contact with the ground path 43 of the main board 40. Preferably, the ground path 43 is electrically connected to the I/O connector 50 mounted at the casing.

An operation of the mobile terminal according to the fourth embodiment will be explained as follows.

When static is channeled on to the periphery of the keys 30 due to the mobile phone being in contact with an object or due to a user pressing the keys 30, static may be introduced into the key K1 on which the conductive layer is formed. Then, the generated static flows on to the ground path 43 through the conducting path 80, and then is discharged outward through the casing, the screws coupled to the casing, and/or the I/O connector 50 mounted at the casing.

In the mobile terminal provided with an electron emitting key pad 100 according to an alternative to the fourth embodiment of the present invention, the pad 70 of the key pad KP may be formed from a transparent material.

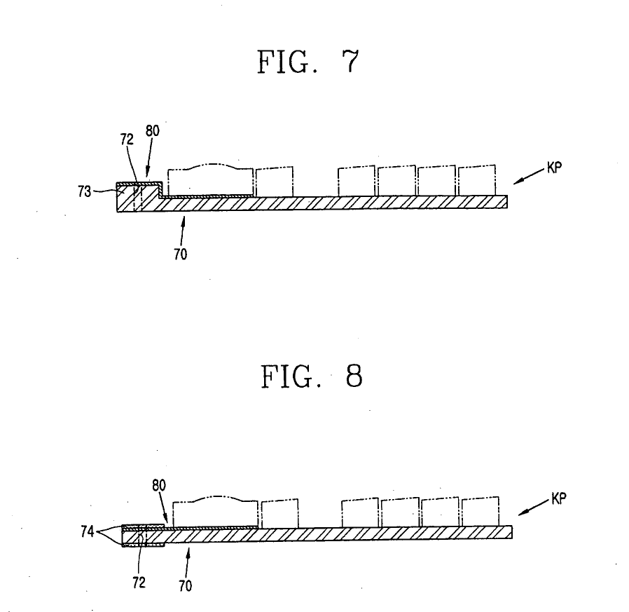

FIG. 7 shows another modification example of the key pad KP of the aforementioned embodiments of the present invention.

As shown, a protrusion portion 73 may be formed on one side of the pad 70 to enhance the contact with the conducting path 80 to the ground path. The protrusion portion 73 may be formed on one side of the conducting path 80 contacting the ground path.

FIG. 8 shows yet another modification example of the key pad KP. As shown, a tape 74 formed from a conductive material may be attached to one side of the key pad KP provided with conducting path 80. The tape 74 may be attached to the pad 70 to be positioned on one side of the conducting path 80 The tape 74 may protrude from the surface of the pad 70.

Preferably, a protrusion portion is formed on one side of the conducting plate 110 of the third embodiment (see FIG. 5) to enhance contact with the ground path 14.

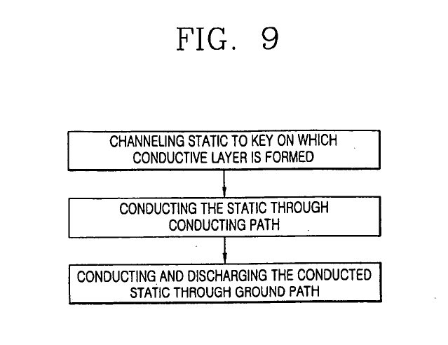

FIG. 9 is a flowchart showing a method for preventing static from accumulating in a mobile terminal according to an embodiment of the present invention. As shown, the method for preventing the mobile terminal may include channeling static to a key on which a conductive layer is formed, conducting the static that has been channeled to the key through a conducting path formed in a body of the mobile terminal, and conducting and discharging the static that has been conducted through a ground path.

That is, when a user presses keys in order to use the mobile terminal, the static generated by the user is channeled to the key on which the conductive layer is formed, the channeled static is conducted to a ground path through a conducting path in the mobile terminal and the static is then discharged through the ground path.

The ground path may be provided on the casing of the terminal body, and the generated static may be conducted and discharged through the ground path provided at the casing.

The ground path can also be provided on the main board of the terminal body, and the generated static may be conducted and discharged through the ground path provided at the main board.

Hereinafter, effects of the mobile terminal capable of preventing accumulation of static electricity and the method thereof will be explained in more detail.

In the mobile terminal according to embodiments of the present invention, when static is generated through the keys, the static is discharged outward through the keys on which a conductive layer is formed, the conducting path, and the ground path. Accordingly, static is prevented from being transmitted to inner components of the mobile terminal, to thereby prevent malfunctioning of the software due to the electrostatic noise and to prevent damages to the hardware, which enhances the reliability of the mobile terminal.

The static prevention as discussed can be applied to all types of mobile terminal including the bar type, flip type, folder type, and slider type.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

1. A mobile terminal capable of preventing accumulation of static, comprising:
a casing;
a key pad provided with one or more keys on which a conductive layer is formed and mounted in the casing; and
a main board mounted in the casing;
a ground path provided at a part of the terminal for conducting and discharging electrostatic; and
a conducting path for conducting the key or keys on which the conductive layer is formed and the ground path.

2. The apparatus of claim 1, wherein the ground path is provided in the casing, and is a conductive thin film formed in a region of the casing.

3. The apparatus of claim 2, wherein the conductive thin film is formed by spraying an EMI material.

4. The apparatus of claim 1, wherein the casing comprises:
a front case including key holes for inserting the keys; and
a rear case coupled to the front case to form an inner space, wherein
the ground path is provided at an inner surface of the front case.

5. The apparatus of claim 4, wherein the ground path is further provided at an inner surface of the rear case, wherein the ground path of the front case and the ground path of the rear case are connected to each other.

6. The apparatus of claim 1, wherein the key pad comprises:
a pad formed of a flexible material; and
a plurality of keys attached to the pad, wherein
the conducting path is provided on the pad.

7. The apparatus of claim 6, wherein the conducting path is formed from a conductive thin film.

8. The apparatus of claim 6, wherein the conducting path is formed from one or more of carbon, copper, gold, and silver.

9. The apparatus of claim 1, wherein the conducting path is formed at a contact surface of the key pad and connecting to the key or keys on which the conductive layer is formed.

10. The apparatus of claim 1, wherein the conducting path comprises:
a first ground portion contacting the key or keys on which the conductive layer is formed;
a second ground portion contacting the ground path; and
a connection portion for connecting the first ground portion to the second ground portion.

11. The apparatus of claim 1, wherein the conducting path is a conducting plate inserted between the key pad and the casing.

12. The apparatus of claim 1, wherein the conducting path is a conductive tape attached to the key pad.

13. The apparatus of claim 1, wherein the keys comprise number keys for inputting numbers or characters and operation keys for inputting operation signals, wherein a conductive layer of metal is formed on one of the operation keys.

14. The apparatus of claim 1, wherein the ground path is electrically connected to a surface of an I/O connector mounted at the casing.

15. The apparatus of claim 14, wherein the ground path is electrically connected to the I/O connector by a conductive gasket.

16. The apparatus of claim 1, wherein the key pad is an electron emitting key pad.

17. The apparatus of claim 1, wherein the ground path is formed on the main board, wherein the ground path is a conductive thin film formed on an edge of the main board contacting the key pad.

18. The apparatus of claim 17, wherein the conductive thin film is formed by spraying an EMI material.

19. A mobile terminal capable of preventing accumulation of static, comprising:
a key on which a conductive layer is formed;
a ground path for conducting and discharging electrostatic; and
a conducting path for conducting to the grouned path the static channeled to the key on which the conductive layer is formed.

20. A method for preventing accumulation of static in a mobile terminal comprising:
channeling the static to a key on which a conductive layer is formed;
conducting the static that has been channeled to the key through a conducting path formed at a part of a terminal body; and
conducting and discharging the electrostatic that has been conducted through a ground path.

21. The method of claim 20, wherein the ground path is provided at a casing of the terminal, and the static is conducted and discharged through the ground path.

22. The method of claim 20, wherein the ground path is provided at a main board of the terminal, and the static is conducted and discharged through the ground path.
